(19) United States
(12) Patent Application Publication
(10) Pub. No.: US 2005/0267734 A1
(43) Pub. Date: Dec. 1, 2005

(54) Translation support program and word association program

(75) Inventor: Akinari Masuyama, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/959,723

(22) Filed: Oct. 6, 2004

(30) Foreign Application Priority Data
May 26, 2004 (JP) 2004-155549

(51) Int. Cl. G06F 17/28

(52) U.S. Cl. 704/2

(57) ABSTRACT

A translation support program that makes association between words or phrases in an original sentence and a corresponding translation sentence easy. A similar translation example retrieval section extracts similar translation examples similar to an input sentence and rearranges the similar translation examples in order according to their similarity degrees. When a search result display section displays search results, first a word association section performs association between words or phrases in a first language sentence in a first language and a second language sentence in a second language included in each similar translation example by the use of a bilingual dictionary. The similar translation examples are displayed in order of similarity degree. Combinations of three sentences, that is to say, of the input sentence and a first language sentence in the first language and a second language sentence in the second language included in each similar translation example are displayed. Corresponding words or phrases in the input sentence and a first language sentence in the first language and a second language sentence in the second language included in each similar translation example are highlighted.

### CROSS-REFERENCE TO RELATED APPLICATIONS

This application is based upon and claims the benefits of priority from the prior Japanese Patent Application No. 2004-155549, filed on May 26, 2004, the entire contents of which are incorporated herein by reference.

### BACKGROUND OF THE INVENTION

(1) Field of the Invention

This invention relates to a translation support program and a word association program and, more particularly, to a translation support program for supporting translation by selecting translation examples similar to a sentence to be translated from among a plurality of translation examples registered in advance and by indicating the translation examples together with the sentence to be translated and a word association program for associating words or phrases in a first language sentence in a first language with words or phrases in a second language sentence in a second language translated from the first language sentence in the first language.

(2) Description of the Related Art

With conventional translation support apparatus for supporting translation of an original sentence to be translated (first language sentence) into a sentence in another language (second language sentence) with a computer, a plurality of translation examples are registered in advance in a database, translation examples similar to the original sentence are selected from among the plurality of translation examples, and the translation examples are indicated to a user together with the original sentence.

With such translation support apparatus, when the original sentence to be translated is inputted, the translation example database is searched and a translation example similar to words or phrases included in the original sentence inputted is extracted. A plurality of translation examples each including a combination of a translation example original sentence expressed in the same language as the original sentence and a translation example translation sentence obtained by translating the translation example original sentence into a target language are stored in the translation example database. In addition to the original sentence, a retrieved translation example original sentence and translation example translation sentence are contrasted and displayed on a display section as a search result to support translation. In this case, corresponding words or phrases in the original sentence and a first language sentence included in the translation example are highlighted so that their correspondence can be grasped.

Moreover, the following technique is proposed so that the correspondence between the original sentence, the translation example original sentence, and the translation example translation sentence can be grasped easily. Correspondence information indicative of the correspondence between words or phrases in the first language sentence and the second language sentence included in the translation example are registered in advance in the translation example database. By using this correspondence information, corresponding words or phrases in the original sentence, the translation example original sentence, and the translation example translation sentence are highlighted. In addition, when one of the highlighted words or phrases is selected, corresponding words or phrases are highlighted more conspicuously (see, for example, Japanese Unexamined Patent Publication No. 2003-330924, paragraph nos. [0022]-[0047] and FIG. 1).

Such highlighting will now be described. FIG. 11 shows an example of a search result display screen on a conventional translation support apparatus.

With the conventional translation support apparatus, a search is made with a search key sentence (original sentence) “I have a pen.” 901 as a search key. Together with the search key sentence (original sentence) 901, a translation example original sentence “I have a pen which I love.” 902 and a corresponding translation example translation sentence 903 written in Japanese, which reads as follows: “WATASHI WA DAISUKI NA PEN WO MO TTE IRU.” are displayed on a search result display screen 900 as a search result. (Note that this is a Romanized representation, or transliteration, of the original Japanese message 903 shown in FIG. 11, which is actually composed of various kinds of characters including Chinese characters.) Then corresponding word “have” 904a, word “have” 904b, and word “MO” 904c in the search key sentence 901, the translation example original sentence 902, and the translation example translation sentence 903, respectively, are highlighted. Similarly, corresponding word “pen” 905a, word “pen” 905b, and word “PEN” 905c in the search key sentence 901, the translation example original sentence 902, and the translation example translation sentence 903, respectively, are highlighted. When the word “pen” 905a, for example, is selected with a mouse or the like, the word “pen” 905a and the corresponding words “pen” 905b and “PEN” 905c are highlighted more conspicuously. As a result, the correspondence between the original sentence and the translation example can be grasped easily.

With the conventional translation support apparatus, however, translation examples each including a translation example original sentence and a corresponding translation example translation sentence and correspondence information indicative of the correspondence between words or phrases in the translation example original sentence and the corresponding translation example translation sentence, that is to say, three types of pieces of information are stored in the translation example database. As described above, not only the translation examples but also the correspondence information is stored, resulting in a large-scale database. This slows search speed.

Furthermore, the correspondence between the translation example original sentence and the translation example translation sentence is extracted on the basis of the correspondence information. Therefore, if the correspondence information is not registered, the correspondence between them cannot be extracted.

FIG. 12 is a view for describing items registered in a translation example database in a conventional translation support apparatus. In this example, a translation example original sentence “I have a favorite pen.” 907 and a corresponding translation example translation sentence 908 written in Japanese, which reads as follows; “WATASHI WA DAISUKI NA PEN WO MO TTE IRU.” are registered. In addition, a correspondence 909 between the words “I” and “WATASHI,” a correspondence 910 between the words “have” and “MO,” and a correspondence 911 between the words “pen” and “PEN” are registered as correspondence information. These pieces of correspondence information enables highlighting on a search result display screen.

However, if a correspondence between, for example, “favorite” 912 in the translation example original sentence 907 and “DAISUKI” 913 in the translation example translation sentence 908 is not registered, then the correspondence between them is not displayed (highlighted) on the search result display screen. Therefore, it is impossible for a user to easily grasp the relationship between the word “favorite” in the translation example original sentence 907 and the word “DAISUKI” in the translation example translation 908. It is difficult for the user to guess correspondence, especially if a large number of words are included in each of a translation example original sentence and a translation example translation sentence or if each of a translation example original sentence and a translation example translation sentence has a complex structure.

Conventionally, correspondence information has been registered by using bilingual dictionaries, so words not included in the bilingual dictionaries at registration time cannot be associated. Usually bilingual dictionaries are updated frequently in order to increase translation accuracy. Therefore, each time bilingual dictionaries are updated, correspondence information must be re-registered. Otherwise correspondence information is not updated.

### SUMMARY OF THE INVENTION

The present invention was made under the background circumstances described above. An object of the present invention is to provide a translation support program for improving translation quality by making association between words or phrases in an original sentence and a translation example easy.

In order to achieve the above object, a translation support program for supporting translation by selecting a translation example similar to a sentence to be translated from among a plurality of translation examples registered in advance and by indicating the translation example together with the sentence to be translated is provided. This translation support program makes a computer perform the processes of inputting a sentence to be translated, being a first language sentence in a first language, and retrieving similar translation examples similar to the sentence to be translated from a translation example storage section that stores translation examples each including a combination of a first language sentence in the first language and a second language sentence in a second language translated from the first language sentence in the first language with the sentence to be translated as a search key; calculating similarity degrees between the retrieved similar translation examples and the sentence to be translated by a predetermined similarity degree calculation method, and arranging the similar translation examples in order according to the similarity degrees; extracting translation words or translation phrases corresponding to words or phrases in the first language sentence in the first language included in each of the similar translation examples from a bilingual dictionary, comparing the translation words or the translation phrases with words or phrases in a second language sentence in the second language included in each of the similar translation examples, and associating the words or the phrases in the first language sentence in the first language included in each of the similar translation examples with the words or the phrases in the second language sentence in the second language included in each of the similar translation examples; and highlighting words or phrases in the sentence to be translated and the first language sentence in the first language and the second language sentence in the second language included in each of the similar translation examples which are associated with each other.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view of the present invention applied to an embodiment.

FIG. 2 shows an example of the hardware configuration of a translation support apparatus according to an embodiment of the present invention.

FIG. 3 is a functional block diagram of the translation support apparatus according to the embodiment of the present invention.

FIG. 4 shows the process of inputting a sentence to be translated to the process of searching for similar translation examples performed in the embodiment of the present invention.

FIG. 5 shows a word association process performed in the embodiment of the present invention.

FIG. 6 shows an example of a search result display screen in the embodiment of the present invention.

FIG. 7 is a flow chart showing the procedure for the word association process performed in the embodiment of the present invention.

FIG. 8 shows an example of steps for generating a node matrix in the word association process performed in the embodiment of the present invention.

FIG. 9 shows an example of a step for setting a word similarity degree in the word association process performed in the embodiment of the present invention.

FIG. 10 shows an example of a step for selecting association in the word association process performed in the embodiment of the present invention.

FIG. 11 shows an example of a search result display screen on a conventional translation support apparatus.

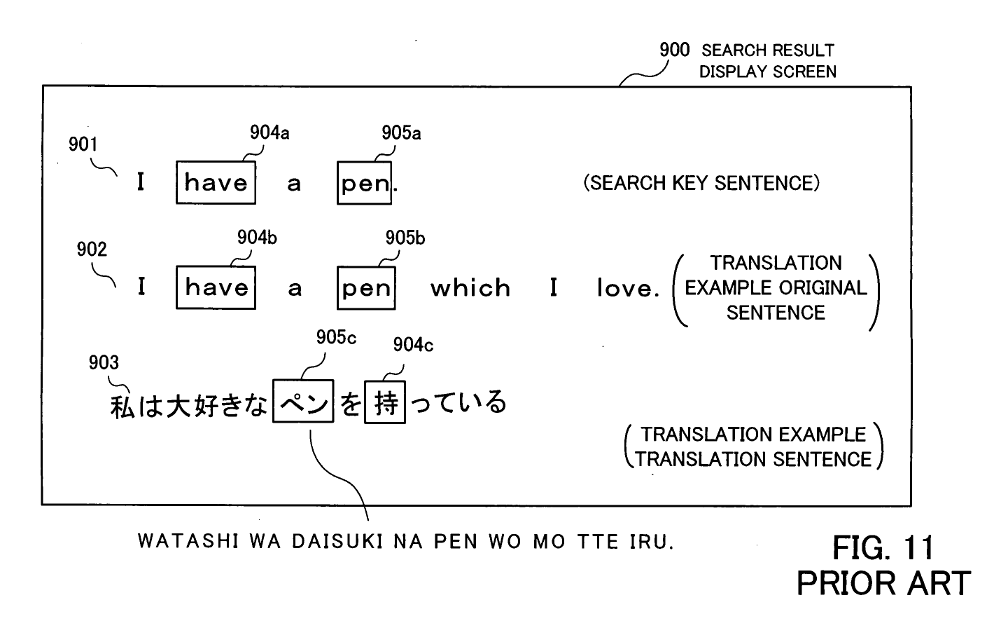

FIG. 12 is a view for describing items registered in a translation example database in a conventional translation support apparatus.

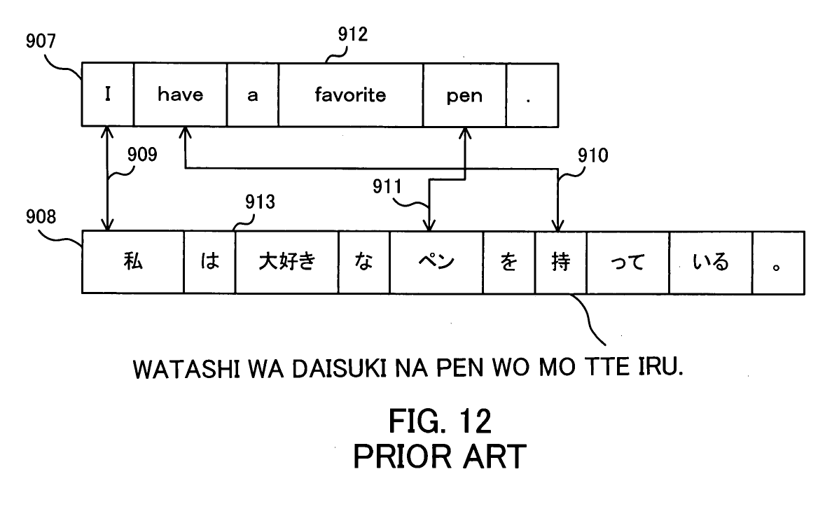

### DESCRIPTION OF THE PREFERRED EMBODIMENTS

An embodiment of the present invention will now be described with reference to the drawings.

This invention supports translation by retrieving a translation example similar to a sentence in a first language to be translated (input sentence) from a translation example database, displaying a first language sentence (translation example original sentence) and a second language sentence (translation example translation sentence) included in the retrieved translation example together with the input sentence, highlighting corresponding words or phrases in these sentences, and making it easy to grasp the correspondence between the words or the phrases.

The present invention applied to an embodiment will schematically be described first. Then the contents of the embodiment will be described concretely.

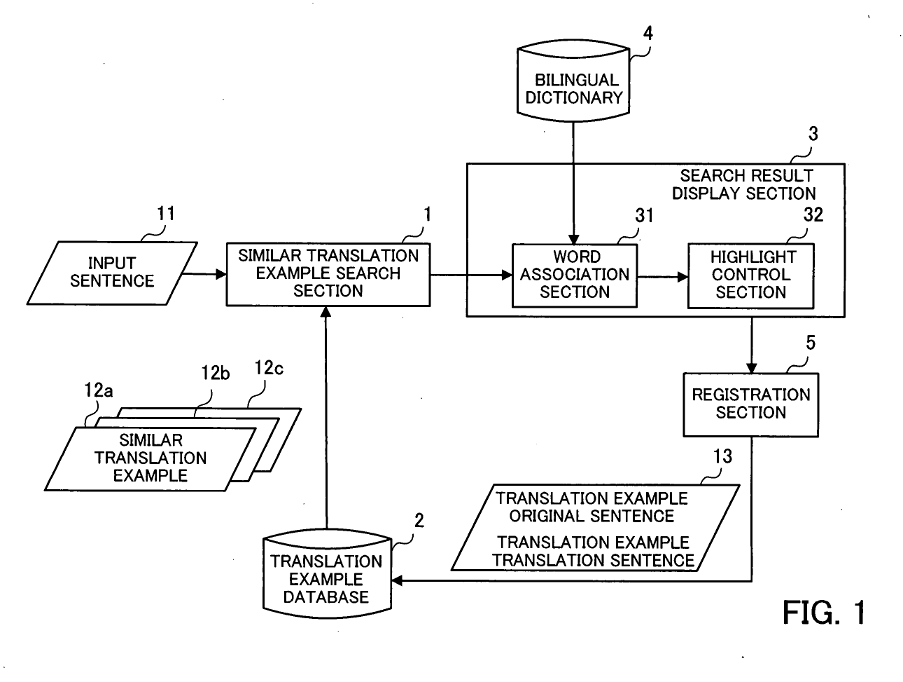

FIG. 1 is a schematic view of the present invention applied to an embodiment. Each processing section in a translation support apparatus according to the present invention functions by making a computer execute a translation support program according to the present invention. This translation support apparatus includes a similar translation example search section 1, a translation example database 2, a search result display section 3, a bilingual dictionary 4, and a registration section 5.

The similar translation example search section 1 searches the translation example database 2 with an input sentence 11 as a search key and extracts similar translation examples 12a, 12b, 12c, etc. similar to the input sentence 11. Then the similar translation example search section 1 calculates a similarity degree between each of the extracted similar translation examples 12a, 12b, 12c, etc. and the input sentence 11 by a predetermined similarity degree calculation method and arranges the extracted similar translation examples according to the calculated similarity degrees. “SCORE,” “RATE,” and the like are known as similarity degree calculation methods. In the present invention, one of them will be selected properly. Moreover, a similarity degree calculation method used for determining whether to rearrange the translation examples should be selected in advance.

A plurality of translation examples each of which consists of a combination of a translation example original sentence and a translation example translation sentence translated from the translation example original sentence are registered in the translation example database 2.

The search result display section 3 displays not only the similar translation examples 12a, 12b, 12c, etc. arranged by the similar translation example search section 1 according to the similarity degrees but also the input sentence 11 as search results. In addition, the search result display section 3 highlights corresponding words or phrases in the input sentence 11 and a translation example original sentence and a translation example translation sentence included in each similar translation example. When one of the highlighted words or phrases is selected, the corresponding words or phrases in the remaining sentences are highlighted more conspicuously. For this reason, a word association section 31 and a highlight control section 32 are included.

The word association section 31 divides a translation example original sentence and a translation example translation sentence included in each of the extracted similar translation examples 12a, 12b, 12c, etc. into words or phrases. Then the word association section 31 searches the bilingual dictionary 4, extracts translation words or translation phrases corresponding to the words or phrases into which the translation example original sentence is divided, and creates a translation word list according to the words or phrases included in the translation example original sentence. The word association section 31 compares the words or phrases included in the translation example translation sentence with the translation word list and finds translation words or translation phrases similar to words or phrases included in the translation example translation sentence. For example, if a translation word or a translation phrase matches a word or a phrase included in the translation example translation sentence, then predetermined marks are given to the translation word or the translation phrase. In addition, marks according to priority set in advance for the translation word or the translation phrase are given. It is decided that if a translation word or a translation phrase obtains high marks, a similarity degree between the translation word or the translation phrase and a word or a phrase in the translation example translation sentence is high. As a result, this word or a phrase in the translation example translation sentence is associated with a word or a phrase in a translation example original sentence having this translation word or translation phrase. If this word or a phrase in the translation example translation sentence is associated with a plurality of words or phrases in the translation example original sentence, association closer to a word or a phrase in the translation example original sentence and a word or a phrase in the translation example translation sentence between which association has been established is selected. The details will be described later.

On the basis of the correspondence between a word or a phrase included the input sentence 11 and a word or a phrase included in the translation example original sentence detected by the similar translation example search section 1 and the correspondence between the word or the phrase included in the translation example original sentence and the word or the phrase included in the translation example translation sentence, the association between which is performed by the word association section 31, the highlight control section 32 highlights corresponding words or phrases included in the input sentence 11, the translation example original sentence, and the translation example translation sentence. In this case, corresponding words or phrases highlighted may be included in the three sentences, be included only in the input sentence 11 and the translation example original sentence, or be included only in the translation example original sentence and the translation example translation sentence. To clarify this correspondence, different colors may be used for highlighting. When one of the highlighted words or phrases is selected by, for example, mouse operation, words or phrases corresponding to the selected word or phrase are highlighted more conspicuously, together with the selected word or phrase.

As stated above, by the highlighting of an input sentence, a translation example original sentence, and a translation example translation sentence by the search result display section 3, a user can easily grasp the correspondence between words or phrases included in these three sentences. By referring to the highlights and editing the translation example translation sentence, a translation sentence corresponding to the input sentence can be generated.

The registration section 5 registers a combination of a translation example translation sentence (edited) included in a similar translation example designated by the user of the search results displayed by the search result display section 3 and the input sentence in the translation example database 2 as a new translation example including a translation example original sentence and a translation example translation sentence.

By using such a translation support apparatus, the translation example database 2 is searched with the input sentence 11 as a search key and the plurality of similar translation examples 12a, 12b, 12c, etc. are extracted and are arranged according to the similarity degrees. In each of the plurality of similar translation examples 12a, 12b, 12c, etc., words or phrases in a translation example original sentence are associated with words or phrases in a translation example translation sentence by extracting translation words or translation phrases corresponding to the words or phrases in the translation example original sentence from the bilingual dictionary 4, comparing the extracted translation words or translation phrases with the words or phrases in the translation example translation sentence, and detecting words or phrases in the translation example translation sentence corresponding to the words or phrases in the translation example original sentence.

By doing so, the similar translation examples arranged according to the similarity degrees are obtained and association between words or phrases in a translation example original sentence and a translation example translation sentence included in each similar translation example is performed. On the basis of these pieces of information, combinations of three sentences, that is to say, of the input sentence and a translation example original sentence and a translation example translation sentence included in a similar translation example are displayed in order of similarity degree as search results. Corresponding words or phrases in the input sentence, a translation example original sentence, and a translation example translation sentence included in each combination are highlighted.

As described above, in the present invention association between words or phrases in a translation example original sentence and a translation example translation sentence included in a translation example is performed after the translation example is extracted as a similar translation example. Association is performed before search results are displayed. Accordingly, association can be performed on the basis of the latest bilingual dictionary. Moreover, only translation example original sentences and translation example translation sentences are stored in the translation example database and correspondence information which has conventionally been needed is not necessary. Therefore, the size of the database can be reduced. This means that time taken to search for a similar translation example can be shortened. Association is performed only between words or phrases included in a translation example, so a long time is not taken to perform association.

A case where an embodiment of the present invention is applied to a translation support apparatus on which, for example, English and Japanese are used as first and second languages, respectively, will now be described in detail with reference to the drawings. Languages used in the present invention are not limited to them.

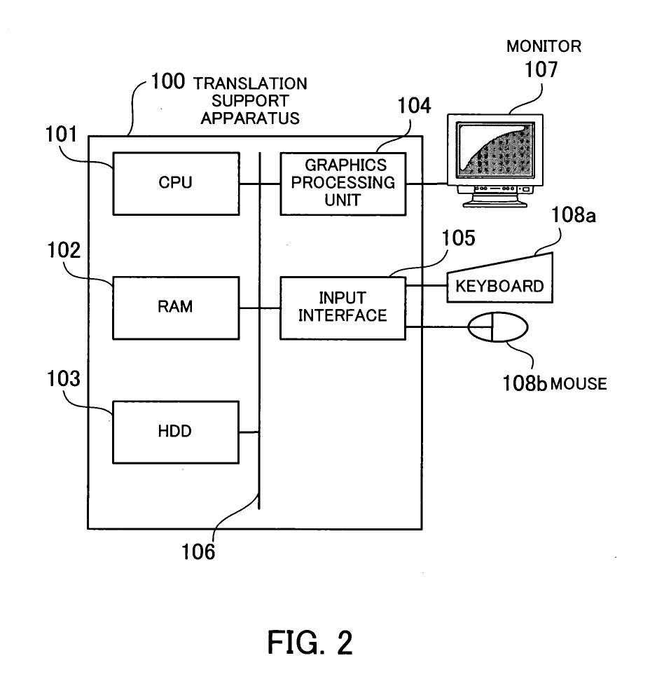

FIG. 2 shows an example of the hardware configuration of a translation support apparatus according to an embodiment of the present invention.

The whole of a translation support apparatus 100 is controlled by a central processing unit (CPU) 101. A random access memory (RAM) 102, a hard disk drive (HDD) 103, a graphics processing unit 104, and an input interface 105 are connected to the CPU 101 via a bus 106.

The RAM 102 temporarily stores at least part of an operating system (OS) or an application program executed by the CPU 101. The RAM 102 stores various pieces of data which the CPU 101 needs to perform a process. The HDD 103 stores the OS and application programs. A monitor 107 is connected to the graphics processing unit 104. In accordance with instructions from the CPU 101, the graphics processing unit 104 displays an image on a screen of the monitor 107. A keyboard 108a and a mouse 108b are connected to the input interface 105. The input interface 105 sends a signal sent from the keyboard 108a or the mouse 108b to the CPU 101 via the bus 106.

A processing function in this embodiment can be realized by the above hardware configuration.

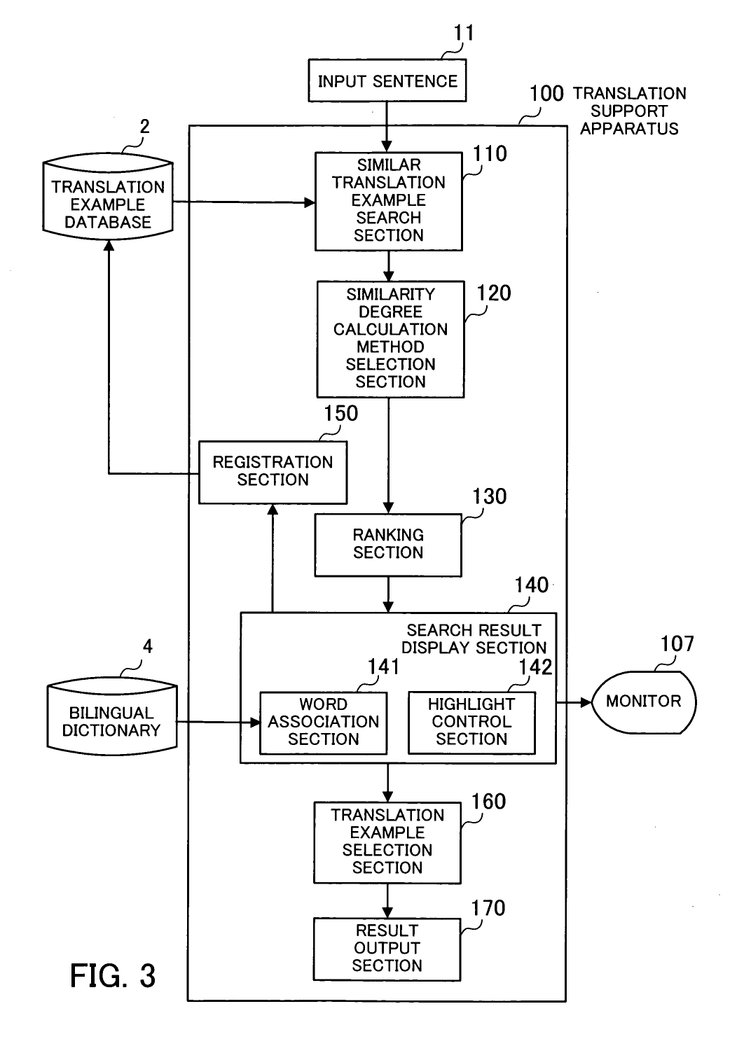

Functional blocks in the translation support apparatus 100 with such a hardware configuration for realizing the processing function described below will now be described. FIG. 3 is a functional block diagram of the translation support apparatus according to the embodiment of the present invention.

The translation support apparatus 100 according to the present invention comprises a similar translation example search section 110, a similarity degree calculation method selection section 120, a ranking section 130, a search result display section 140, a registration section 150, a translation example selection section 160, and a result output section 170.

When the input sentence 11 is inputted, the similar translation example search section 110 searches the translation example database 2 with the input sentence 11 as a search key and extracts a plurality of similar translation examples similar to the input sentence 11.

The similarity degree calculation method selection section 120 selects a similarity degree calculation method for ranking the plurality of similar translation examples extracted by the similar translation example search section 110. A user designates any of similarity degree calculation methods which can be used on the translation support apparatus as the similarity degree calculation method for ranking.

The ranking section 130 calculates a similarity degree between each of the plurality of similar translation examples extracted by the similar translation example search section 110 and the input sentence 11. In this case, predetermined methods including at least the similarity degree calculation method for ranking selected by the similarity degree calculation method selection section 120 are used. The plurality of similar translation examples are rearranged according to the calculated similarity degrees so that they will be arranged in descending order of similarity degree. The similarity degrees used for rearranging the plurality of similar translation examples are selected by the similarity degree calculation method selection section 120.

The search result display section 140 displays combinations of three sentences, that is to say, of a translation example original sentence and a translation example translation sentence included in a similar translation example and the input sentence 11 on the monitor 107 in the order in which the plurality of similar translation examples are arranged after being rearranged by the ranking section 130. At this time corresponding words or phrases in the input sentence 11, the translation example original sentence, and the translation example translation sentence are highlighted by a word association section 141 and a highlight control section 142. The word association section 141 performs association between words or phrases in a translation example original sentence and a translation example translation sentence included in each similar translation example by the use of the bilingual dictionary 4. The highlight control section 142 highlights words or phrases in the translation example original sentence, the translation example translation sentence, and the input sentence 11 associated with one another. In addition, when one of the highlighted words or phrases is selected by the user, the selected word or phrase and the corresponding words or phrases in the other sentences are highlighted more conspicuously.

The registration section 150 stores a combination of the input sentence and a translation example translation sentence designated by the user of the search results displayed on the monitor 107 in the translation example database 2 as a new translation example.

The translation example selection section 160 outputs a translation example translation sentence or a phrase or a word in a translation example translation sentence in a similar translation example selected by the user from among the search results displayed by the search result display section 140 with a pointing device, such as a mouse.

The result output section 170 outputs the translation example translation sentence included in the similar translation example selected by the translation example selection section 160 as the translation result of the input sentence, that is to say, of the sentence to be translated.

Operation performed when an input sentence 200 is inputted into the translation support apparatus 100 having such a structure will be described.

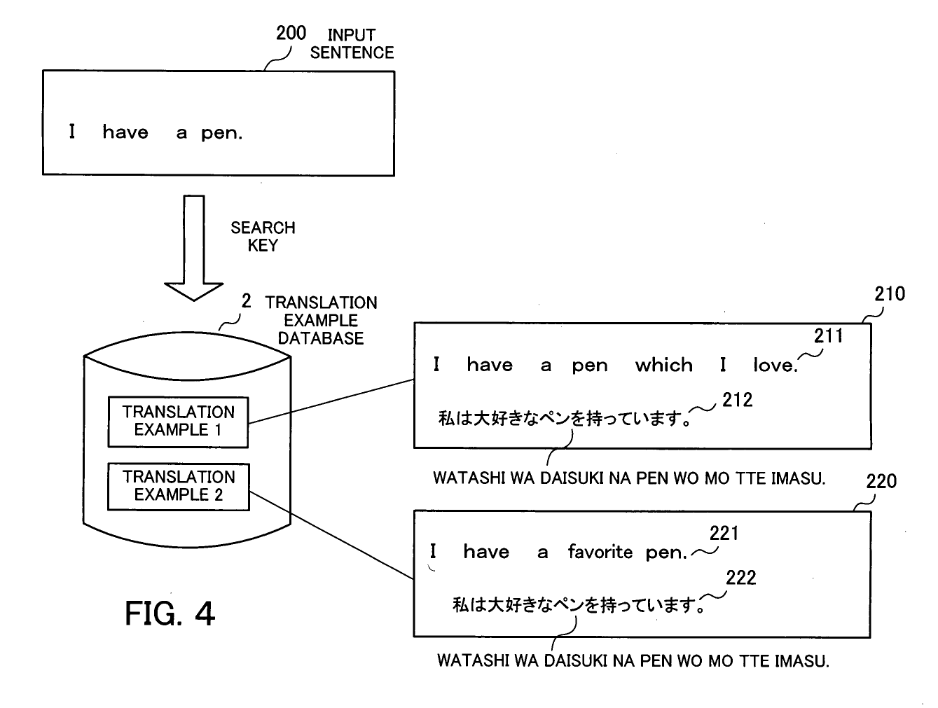

FIG. 4 shows the process of inputting a sentence to be translated to the process of searching for similar translation examples performed in the embodiment of the present invention.

When the input sentence (in this example, “I have a pen.”) 200, being a sentence to be translated, is inputted, the similar translation example search section 110 searches the translation example database 2 in which many translation examples are stored in advance with the input sentence 200 as a search key. In this case, translation example 1 (210) and translation example 2 (220) are extracted as similar translation examples. Translation example 1 (210) consists of a translation example original sentence “I have a pen which I love.” 211 and a translation example translation sentence 212 written in Japanese, which reads as follows: “WATASHI WA DAISUKI NA PEN WO MO TTE IMASU.” Translation example 2 (220) consists of a translation example original sentence “I have a favorite pen.” 221 and a translation example translation sentence 222 written in Japanese, which reads as follows: “WATASHI WA DAISUKI NA PEN WO MO TTE IMASU.”

Similarity degrees for the similar translation examples extracted in this way are calculated. A case where “SCORE” is used as a similarity degree calculation method and a case where “RANK” is used as a similarity degree calculation method will now be described.

First, the similarity degree calculation method selection section 120 determines a similarity degree calculation method used for ranking search results to be displayed. In this example, “SCORE” and “RANK” are used as similarity degree calculation methods, but “SCORE” is used for ranking.

Next, the ranking section 130 calculates “SCORE” and “RANK” for translation example 1 (210) and translation example 2 (220) to rank them.

With “SCORE,” if words or phrases in a search key sentence (input sentence) continuously match words or phrases in a compared sentence (translation example original sentence), a similarity degree between them is high. A similarity degree [SCORE] is given by
[SCORE]=N*(N+1)/2 (1)
where N is the number of comparison units (words or phrases) in the search key sentence that match comparison units in the compared sentence.

For example, the four words “I,” “have,” “a,” and “pen” in the input sentence 200 continuously match the four words “I,” “have,” “a,” and “pen” in the translation example original sentence 211 included in translation example 1 (210). Therefore, [SCORE]=4*(4+1)/2=10. Similarly, the three words “I,” “have,” and “a” in the input sentence 200 continuously match the three words “I,” “have,” and “a” in the translation example original sentence 221 included in translation example 2 (220). [SCORE] (for these three words)=3*(3+1)/2=6. Moreover, the word “pen” in the input sentence 200 matches the word “pen” in the translation example original sentence 221 included in translation example 2 (220). [SCORE] (for this word)=1*(1+1)/2=1. Accordingly, in total, [SCORE]=7.

With “RANK,” a similarity degree is expressed by the percentage of comparison units (words or phrases) in a search key sentence (input sentence) that match comparison units in a compared sentence (translation example original sentence) to all comparison units. [RANK] is given by
[RANK]=(A*2)/(B+C) (2)
where A is the number of comparison units in the search key sentence (input sentence) that match comparison units in the compared sentence (translation example original sentence), B is the number of comparison units included in the search key sentence (input sentence), and C is the number of comparison units included in the compared sentence (translation example original sentence).

For example, the four words “I,” “have,” “a,” and “pen” in the input sentence 200 match the four words “I,” “have,” “a,” and “pen” in the translation example original sentence 211 included in translation example 1 (210). The number of the comparison units included in the input sentence 200 is 4 and the number of the comparison units included in the translation example original sentence 211 is 7. Therefore, [RANK]=4*2/(4+7)=0.72(=72%). Similarly, the four words “I,” “have,” “a,” and “pen” in the input sentence 200 match the four words “I,” “have,” “a,” and “pen” in the translation example original sentence 221 included in translation example 2 (220). The number of the comparison units included in the input sentence 200 is 4 and the number of the comparison units included in the translation example original sentence 221 is 5. Therefore, [RANK]=4*2/(4+5)=0.88(=88%).

In this case, ranking is performed by “SCORE,” so translation example 1 (210) and translation example 2 (220) are arranged in that order.

Then the search result display section 140 displays the search results on the monitor 107.

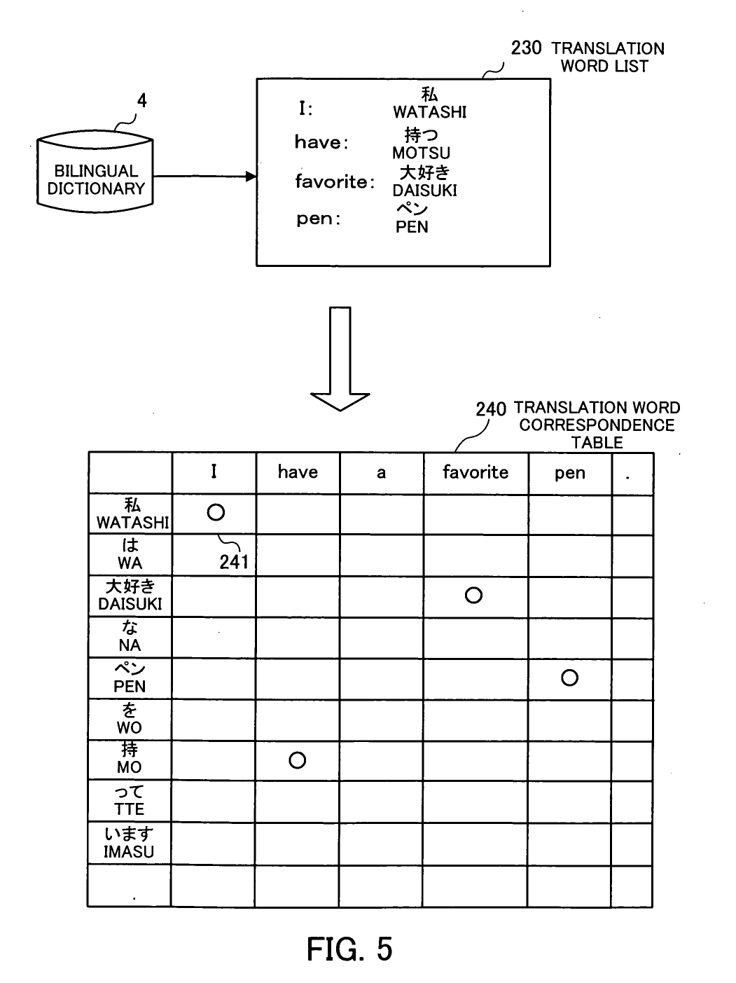

The word association section 141 refers to the bilingual dictionary 4 and performs association between words or phrases in a translation example original sentence and a translation example translation sentence included in each similar translation example. FIG. 5 shows a word association process performed in the embodiment of the present invention. In FIG. 5, association is performed between the words or phrases in the translation example original sentence 221 and the translation example translation sentence 222 included in translation example 2 (220).

First, the word association section 141 performs morphological analysis of the translation example original sentence 221 and the translation example translation sentence 222 included in translation example 2 to divide them into words or phrases (nodes). Then the word association section 141 searches the bilingual dictionary 4, extracts translation words according to the nodes included in the translation example original sentence 221, and draws up a translation word list 230. In this example, “I=WATASHI,” “have=MOTSU,” “favorite=DAISUKI,” and “pen=PEN” are registered in the translation word list 230 as a result of the search.

A matrix in which the nodes included in the translation example original sentence 221 are arranged in a row and in which the nodes included in the translation example translation sentence 222 are arranged in a column is created as a translation word correspondence table 240. The translation words are compared with the nodes included in the translation example translation sentence 222. For example, the translation word “WATASHI” for the first node “I” in the translation example original sentence 221 matches the first node in the translation example translation sentence 222, so correspondence (in this example, ◯) is set in a field 241 where the column including the first node “I” in the translation example original sentence 221 and the row including the first node in the translation example translation sentence 222 intersect in order to associate them with each other. In addition, the second node “have” in the translation example original sentence 221 is associated with the seventh node “MO” in the translation example translation sentence 222 via the translation word “MOTSU”. Similarly, the fourth node “favorite” in the translation example original sentence 221 is associated with the third node “DAISUKI” in the translation example translation sentence 222 and the fifth node “pen” in the translation example original sentence 221 is associated with the fifth node “PEN” in the translation example translation sentence 222.

In a case where a translation example original sentence is expressed in Japanese and a translation example translation sentence is expressed in English, association is performed in the same way.

By following the above procedure, correspondences between nodes in the translation example original sentence and the translation example translation sentence become clear. Translation examples each of which is a combination of three sentences, that is to say, of an input sentence, a translation example original sentence, and a translation example translation sentence are displayed in the order in which they are ranked by the ranking section 130 on the monitor 107 as search results. At this time the highlight control section 142 highlights corresponding nodes in three sentences included in each translation example by using the correspondences which have become clear as a result of the analysis by the word association section 141.

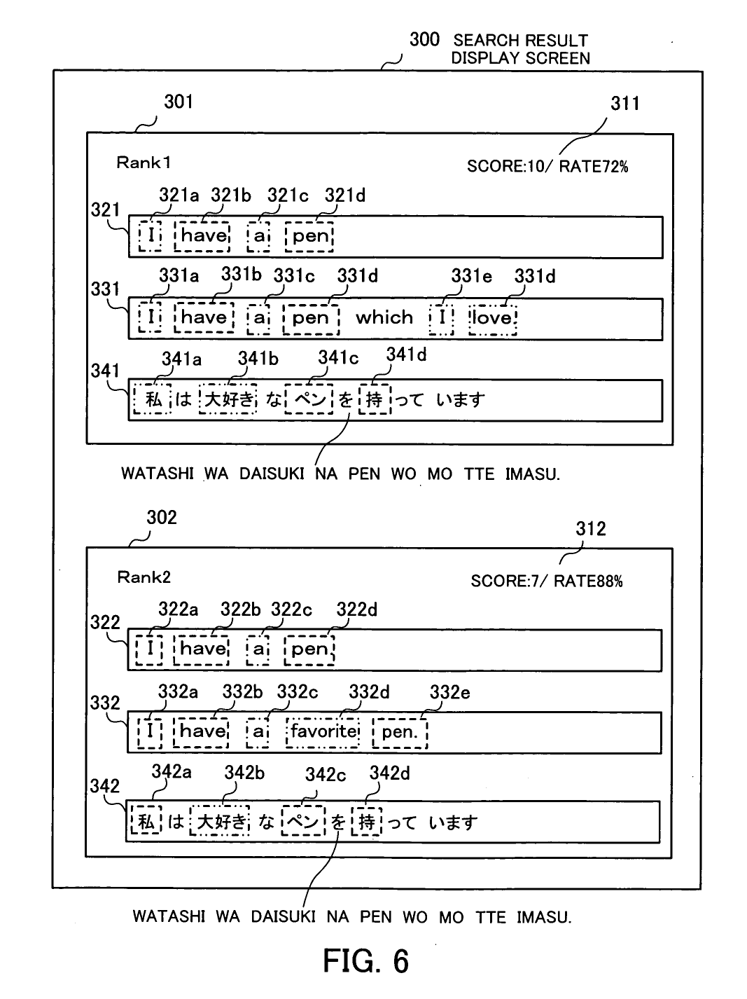

FIG. 6 shows an example of a search result display screen in the embodiment of the present invention.

Rank1 301 and Rank2 302 which are ranked first and second, respectively, as a result of ranking by the ranking section 130 are displayed on a search result display screen 300. A calculated similarity degree (SCORE/RATE) 311, an input sentence 321, a translation example original sentence 331, and a translation example translation sentence 341 are displayed in Rank1 301. Similarly, a calculated similarity degree (SCORE/RATE) 312, an input sentence 322, a translation example original sentence 332, and a translation example translation sentence 342 are displayed in Rank2 302. In this example, translation example 1 (210) is displayed in Rank1 301 and translation example 2 (220) is displayed in Rank2 302.

Moreover, the highlight control section 142 palely highlights corresponding nodes in three sentences included in each translation example. In FIG. 6, highlighted nodes are enclosed by chain lines, one-dot chain lines, or two-dot chain lines. Corresponding nodes in an input sentence, a translation example original sentence, and a translation example translation sentence are enclosed by chain lines. Corresponding nodes in an input sentence and a translation example original sentence are enclosed by one-dot chain lines. Corresponding nodes in a translation example original sentence and a translation example translation sentence are enclosed by two-dot chain lines.

For example, in Rank1 301, “I” 321a and “a” 321c in the input sentence 321 enclosed by one-dot chain lines correspond to “I” 331a and “a” 331c, respectively, in the translation example original sentence 331. “have” 321b and “pen” 321d in the input sentence 321 enclosed by chain lines correspond to “have” 331b and “pen” 331d, respectively, in the translation example original sentence 331 and correspond to “MO” 341d and “PEN” 341c, respectively, in the translation example translation sentence 341. In addition, “I” 331e and “love” 331d in the translation example original sentence 331 enclosed by two-dot chain lines correspond to “WATASHI” 341a and “DAISUKI” 341b, respectively, in the translation example translation sentence 341.

Similarly, in Rank2 302, “I” 322a, “have” 322b, and “pen” 322d in the input sentence 322 enclosed by chain lines correspond to “I” 332a, “have” 332b, and “pen” 332e, respectively, in the translation example original sentence 332 and correspond to “WATASHI” 342a, “MO” 342d, and “PEN” 342c, respectively, in the translation example translation sentence 342. In addition, “a” 322b in the input sentence 322 corresponds to “a” 332c in the translation example original sentence 332 and “favorite” 332d in the translation example original sentence 332 corresponds to “DAISUKI” 342b in the translation example translation sentence 342.

By highlighting corresponding nodes in this way, correspondences between words or phrases in sentences can be grasped easily.

Moreover, when one of these nodes is selected by a user, the highlight control section 142 highlights this node and the corresponding nodes in the other sentences more conspicuously. For example, when “pen” 321d is selected, “pen” 331d and “PEN” 341c, together with “pen” 321d, are highlighted more conspicuously. As a result, the correspondence becomes clearer.

On an actual display screen, this correspondence becomes clear by, for example, changing the color of these nodes.

In the above description, a node in a translation example original sentence (original sentence) is associated with a node in a translation example translation sentence (translation sentence) that matches a translation word for the node in the original sentence. However, if a large number of nodes are included in the original sentence or if the original sentence has a complex structure, a plurality of nodes in the translation sentence may match a translation word for one node in the original sentence. In such a case, it is difficult to perform association by the above method. Therefore, a word similarity degree for each node is calculated and a word association process is performed on the basis of this word similarity degree.

A word similarity degree is determined in the following way. A translation word for a node in the original sentence and a node in the translation sentence are compared. Each time a preset condition is met, marks set for the condition are given. A word similarity degree is determined by the number of marks obtained. For example, it is assumed that each time one of the following conditions is met, marks set for the condition are given.

(1) If a translation word for a node in the original sentence matches a node in the translation sentence, a mark of 10 is given.

(2) If a translation word of the highest priority of translation words for a node in the original sentence matches a node in the translation sentence, a mark of 10 is given.

(3) If a node in the original sentence matches a node in the translation sentence in representation, a mark of 3 is given.

A node in the original sentence is associated with a node in the translation sentence which obtains higher marks.

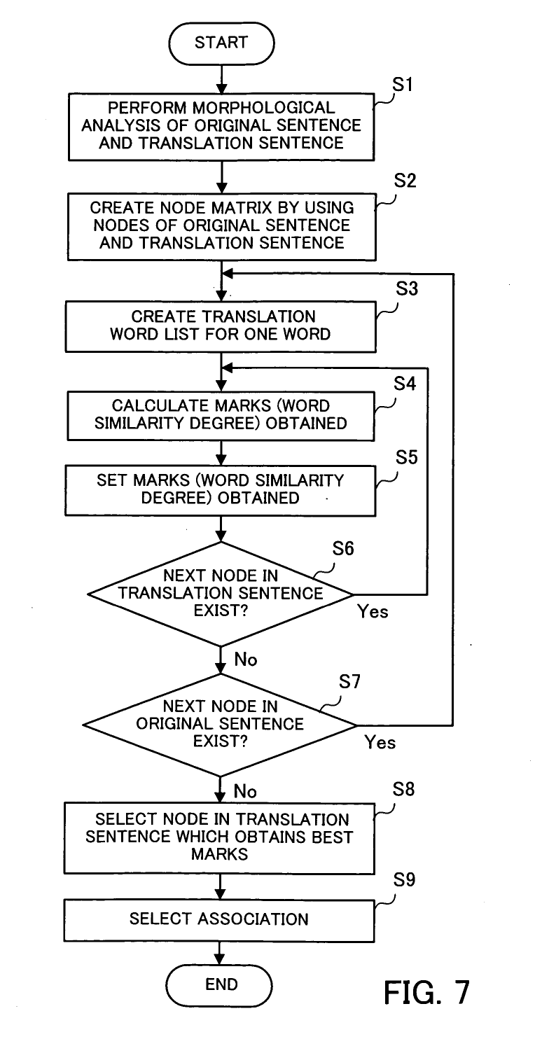

The procedure for this word association process will be described. FIG. 7 is a flow chart showing the procedure for the word association process performed in the embodiment of the present invention.

An original sentence and a translation sentence are inputted to begin a process.

[Step S1] Morphological analysis of the original sentence and the translation sentence inputted is performed and the original sentence and the translation sentence are divided into nodes.

[Step S2] A matrix (node matrix) is created by using the nodes of the original sentence and the translation sentence.

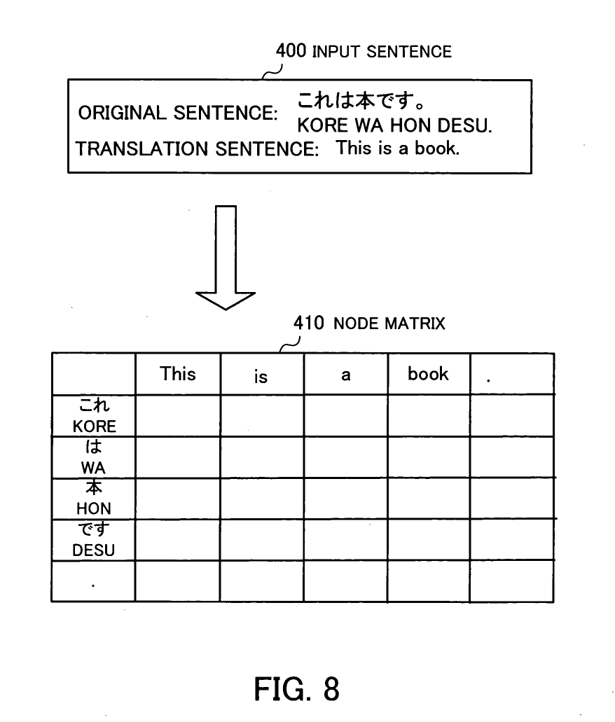

By performing the above steps, the node matrix of the nodes of the original sentence and the translation sentence is created. These steps will be described by giving a concrete example. FIG. 8 shows an example of steps for generating a node matrix in the word association process performed in the embodiment of the present invention.

In this example, an input sentence 400 including the original sentence “KORE WA HON DESU.” and the translation sentence “This is a book.” is inputted and morphological analysis of the original sentence and the translation sentence is performed. In this case, the original sentence is divided into “KORE/WA/HON/DESU/.” and the translation sentence is divided into “This/is/a/book/.”. A node matrix 410 is created by using the nodes obtained by the division. In the matrix shown in FIG. 8, the nodes of the translation sentence are arranged in a row and the nodes of the original sentence are arranged in a column.

To return to FIG. 7, the following steps are performed.

[Step S3] A node (one word) is taken from the original sentence, the bilingual dictionary is searched, and a translation word list is created. Priority for each translation word is registered in advance in the bilingual dictionary. In the following description, it is assumed that priority for translation words is set in the order in which they appear in the bilingual dictionary.

[Step S4] A node is taken from the translation sentence, whether the node is included in the translation word list created in step S3 is checked, and marks (word similarity degree) obtained under the above conditions are calculated. For example, if the node taken from the translation sentence is included in the translation word list, then condition (1) is met and a mark of 10 is given. Moreover, if top priority is given to the corresponding translation word in the translation word list (that is to say, the corresponding translation word is placed first on the translation word list), then condition (2) is met and an additional mark of 10 is given. In addition, If the node in the original sentence matches the node in the translation sentence in representation, then condition (3) is met and a mark of 3 is given. If a word (for example, “CPU”) is represented the same both in Japanese and in English, condition (3) is met. If any of these conditions is not met, a mark of 0 is given.

[Step S5] The marks (word similarity degree) calculated in step S4 is set in a field where the row including the node in the original sentence (corresponding to the translation word) currently selected and the column including the node in the translation sentence currently selected intersect.

[Step S6] Whether the next node exists in the translation sentence is decided. If the next node exists in the translation sentence, then step S4 is performed to calculate marks obtained.

[Step S7] Whether the next node exists in the original sentence is decided. If the next node exists in the original sentence, then step S3 is performed to create a translation word list.

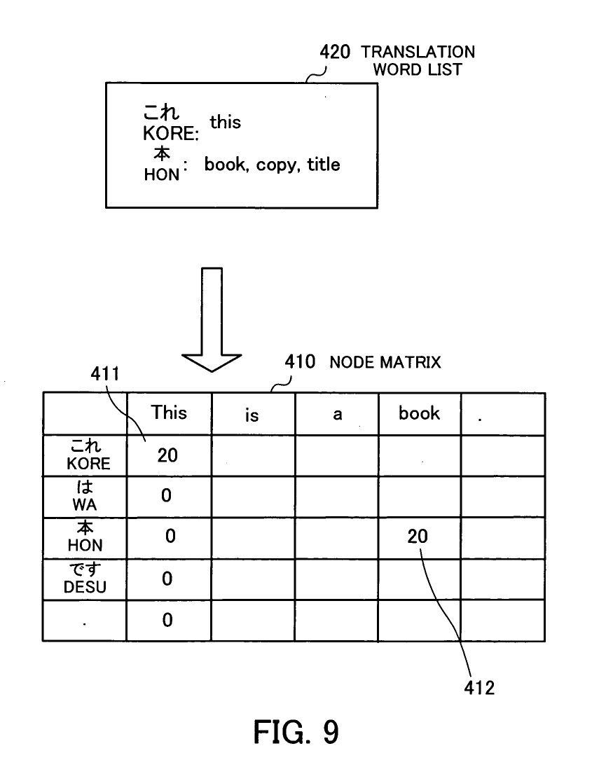

By performing the above steps, marks (word similarity degree) are set in each field in the node matrix. These steps will be described by giving a concrete example. FIG. 9 shows an example of a step for setting a word similarity degree in the word association process performed in the embodiment of the present invention.

By performing the above steps, a translation word list 420 for nodes in the original sentence included in the input sentence 400 is created. In this example, the translation word “this” is retrieved for the first node “KORE” in the original sentence and the translation words “book,” “copy,” and “title” are retrieved for the third node “HON” in the original sentence. In this case, top priority is given to the translation words “this” and “book”.

For example, the first node “this” in the translation sentence corresponds to the translation word “this” for “KORE” included in the translation word list 420, so a mark of 10 is given. Moreover, top priority is given to “this,” so an additional mark of 10 is given. As a result, a total mark of 20 is obtained. Therefore, a mark of 20 is set in a field 411 where the row including the first node “KORE” in the original sentence and the column including the first node “this” in the translation sentence intersect. The first node “this” in the translation sentence is not included in the translation word list for the other nodes in the original sentence, so a mark of 0 is set in the other fields in this column. Similarly, the fourth node “book” in the translation sentence corresponds to the translation word “book” of the highest priority of the translation words for the third node “HON” in the original sentence. Therefore, a mark of 20 is set in a field 412 where the row including the third node “HON” in the original sentence and the column including the fourth node “book” in the translation sentence intersect.

To return to FIG. 7, the following steps are performed.

[Step S8] The node matrix in which marks (word similarity degrees) are set is referred to and association between the nodes in the original sentence and the nodes in the translation sentence is performed. The marks are referred to and a node in the translation sentence which obtains the best marks is associated with the corresponding node in the original sentence. In the example shown in FIG. 9, the first node “KORE” in the original sentence is associated with the first node “This” in the translation sentence. Similarly, the third node “HON” in the original sentence is associated with the fourth node “book” in the translation sentence.

[Step S9] A plurality of nodes in the translation sentence may obtain the same marks (word similarity degree) In this case, a node pair which is closer to a node pair including the node in the original sentence and the node in the translation sentence between which association is determined in step S8 is selected from a plurality of node pairs each including a node in the original sentence and a node in the translation sentence. In the above examples, the association between a node in the original sentence and a node in the translation sentence can be performed on the basis of a word similarity degree. However, there are cases where the same marks are given to a plurality of nodes in a translation sentence.

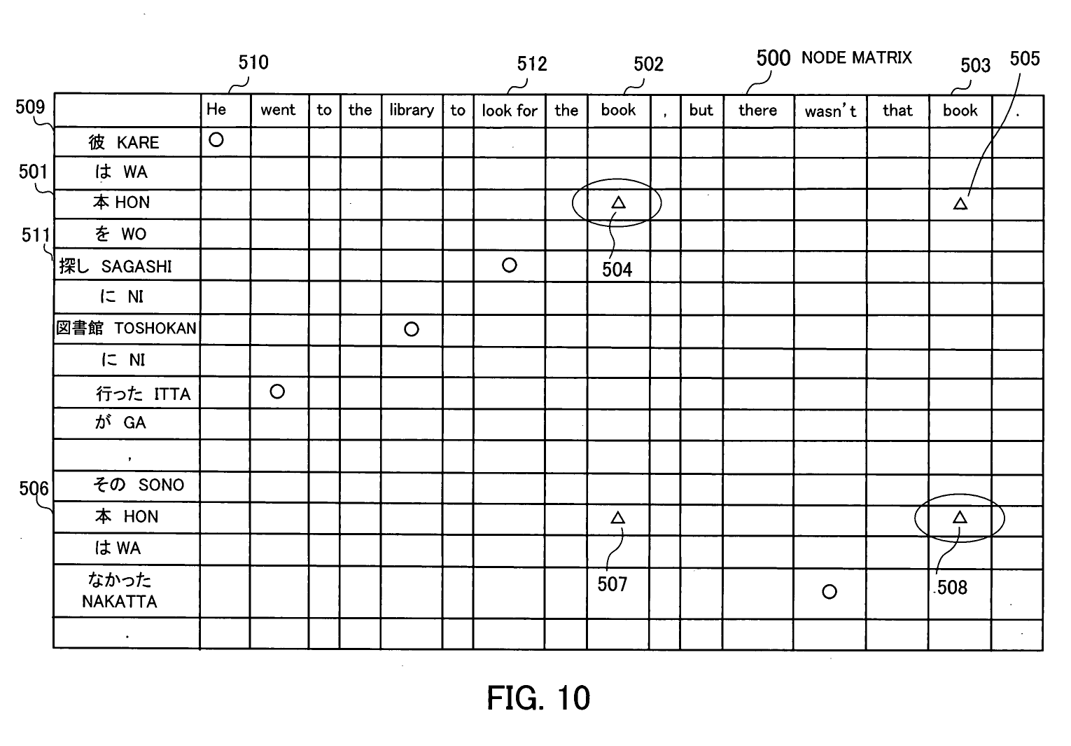

Descriptions will be given by showing a concrete example. FIG. 10 shows an example of a step for selecting association in the word association process performed in the embodiment of the present invention.

Morphological analysis of the original sentence “KARE WA HON WO SAGASHI NI TOSHOKAN NI ITTA GA SONO HON WA NAKATTA.” and the translation sentence “We went to the library to look for the book, but there wasn't that book.” is performed and a node matrix 500 is created by using the nodes of the original sentence and the translation sentence.

The translation word “book” for a third node “HON” 501 in the original sentence corresponds to a ninth node “book” 502 and a fifteenth node “book” 503 in the translation sentence. Therefore, the same marks (Δ) are set in a field 504 where the row including the third node 501 in the original sentence and the column including the ninth node 502 in the translation sentence intersect and a field 505 where the row including the third node 501 in the original sentence and the column including the fifteenth node 502 in the translation sentence intersect. Similarly, the translation word “book” for a thirteenth node “HON” 506 in the original sentence corresponds to the ninth node “book” 502 and the fifteenth node “book” 503 in the translation sentence. Therefore, the same marks (Δ) are set in a field 507 where the row including the thirteenth node 506 in the original sentence and the column including the ninth node 502 in the translation sentence intersect and a field 508 where the row including the thirteenth node 506 in the original sentence and the column including the fifteenth node 503 in the translation sentence intersect.

As stated above, there are two node pairs each including the third node “HON” 501 in the original sentence. One node pair includes the third node “HON” 501 in the original sentence and the ninth node “book” 502 in the translation sentence and the other node pair includes the third node “HON” 501 in the original sentence and the fifteenth node “book” 503 in the translation sentence. Similarly, there are two node pairs each including the thirteenth node “HON” 506 in the original sentence. One node pair includes the thirteenth node “HON” 506 in the original sentence and the ninth node “book” 502 in the translation sentence and the other node pair includes the thirteenth node “HON” 506 in the original sentence and the fifteenth node “book” 503 in the translation sentence.

If the same method is used, only a first node “He” 510 in the translation sentence corresponds to a first node “KARE” 509 in the original sentence. Accordingly, the association between the first node “KARE” 509 in the original sentence and the first node “He” 510 in the translation sentence is established. Similarly, the association between a fifth node “SAGASHI” 511 in the original sentence and a seventh node “look for” 512 in the translation sentence is also established.

The relationship between the third node “HON” 501 in the original sentence and each node pair including nodes between which association has been established is as follows. The field 504 where the row including the third node “HON” 501 in the original sentence and the column including the ninth node “book” 502 in the translation sentence intersect is closer to a node pair including the first node “KARE” 509 in the original sentence and the first node “He” 510 in the translation sentence between which association has been established and a node pair including the fifth node “SAGASHI” 511 in the original sentence and the seventh node “look for” 512 in the translation sentence between which association has been established. Therefore, the field 504 is selected. As a result, the association between the third node “HON” 501 in the original sentence and the ninth node “book” 502 in the translation sentence is established. The ninth node “book” 502 in the translation sentence has already been selected, so the thirteenth node “HON” 506 in the original sentence is associated with the fifteenth node “book” 503 in the translation sentence. As a result, the association between the third node “HON” 501 in the original sentence and the ninth node “book” 502 in the translation sentence and between the thirteenth node “HON” 506 in the original sentence and the fifteenth node “book” 503 in the translation sentence is established.

It is generally known by a rule of thumb that if a plurality of nodes in a translation sentence can be associated with one node in an original sentence, the correspondence between the node in the original sentence and a node in the translation sentence included in a node pair closer to a node pair including a node in the original sentence and a node in the translation sentence which are associated with each other on a one-to-one basis will be reliable.

By performing the above steps, the association between nodes in the original sentence and nodes in the translation sentence is established.

In the above description, the word association process is performed in the search result display process. However, a word association process may be performed independently. For example, when a user wants to know the correspondence between a translation example original sentence and a corresponding translation example translation sentence included in document data, he/she inputs the translation example original sentence and the translation example translation sentence and performs a word association process. In this case, he/she makes a computer execute a word association program. This word association process is performed by the same steps that are followed in the word association process shown in FIG. 7, so descriptions of them will be omitted.

The above functions can be realized with a computer. In this case, a program in which the contents of the functions the translation support apparatus should have are described is provided. By executing this program on the computer, the above functions are realized on the computer. This program can be recorded on a computer readable record medium. A computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a digital versatile disk random access memory (DVD-RAM), a compact disk read only memory (CD-ROM), a compact disk recordable (CD-R)/rewritable (CD-RW), or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then the computer reads the program from its hard disk and performs processes in compliance with the program. The computer can also read the program directly from a portable record medium and perform processes in compliance with the program. Furthermore, each time the program is transferred from the server computer, the computer can perform processes in turn in compliance with the program it receives.

As has been described in the foregoing, on a computer which executes the translation support program according to the present invention, a similar translation example similar to a sentence to be translated, being a first language sentence expressed in a first language, is searched for. When a search result is displayed, association between words or phrases in a first language sentence and a second language sentence included in the similar translation example is performed. Accordingly, when the search result is displayed, the correspondence between words or phrases in the sentence to be translated and the first language sentence and the second language sentence included in the similar translation example can be displayed on the basis of the latest bilingual dictionary. This improves translation quality. Moreover, there is no need to store correspondence information indicative of correspondence in a translation example database. Accordingly, the size of the database can be reduced and time taken to search for a similar translation example can be reduced.

In addition, on the computer which executes the word association program according to the present invention, association between words or phrases in the first language sentence and the second language sentence is automatically performed on the basis of the bilingual dictionary. As a result, correspondence information can be created on the basis of the bilingual dictionary updated.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A translation support program for supporting translation by selecting translation examples similar to a sentence to be translated from among a plurality of translation examples registered in advance and by indicating the translation examples together with the sentence to be translated, the program making a computer perform the processes of:
inputting a sentence to be translated, being a first language sentence in a first language, and retrieving similar translation examples similar to the sentence to be translated from a translation example storage section that stores translation examples each including a combination of a first language sentence in the first language and a second language sentence in a second language translated from the first language sentence in the first language with the sentence to be translated as a search key;
calculating similarity degrees between the retrieved similar translation examples and the sentence to be translated by a predetermined similarity degree calculation method, and arranging the similar translation examples in order according to the similarity degrees;
extracting translation words or translation phrases corresponding to words or phrases in the first language sentence in the first language included in each of the similar translation examples from a bilingual dictionary, comparing the translation words or the translation phrases with words or phrases in a second language sentence in the second language included in each of the similar translation examples, and associating the words or the phrases in the first language sentence in the first language included in each of the similar translation examples with the words or the phrases in the second language sentence in the second language included in each of the similar translation examples; and
highlighting words or phrases in the sentence to be translated and the first language sentence in the first language and the second language sentence in the second language included in each of the similar translation examples which are associated with each other.

2. The translation support program according to claim 1, wherein when words or phrases in the first language sentence in the first language included in each of the similar translation examples are associated with words or phrases in the second language sentence in the second language included in each of the similar translation examples, the bilingual dictionary is searched according to the words or the phrases in the first language sentence in the first language included in each of the similar translation examples and a translation word list corresponding to each of the words or the phrases is created, the translation words or the translation phrases included in the translation word list are compared with the words or the phrases in the second language sentence in the second language included in each of the similar translation examples, and words or phrases in the first language sentence in the first language included in each of the similar translation examples which have the same translation words or translation phrases as words or phrases in the second language sentence in the second language included in each of the similar translation examples are associated with the words or the phrases in the second language sentence in the second language included in each of the similar translation examples.

3. The translation support program according to claim 1, wherein when words or phrases in the first language sentence in the first language included in each of the similar translation examples are associated with words or phrases in the second language sentence in the second language included in each of the similar translation examples, the translation words or the translation phrases are compared with each word or each phrase in the second language sentence in the second language included in each of the similar translation examples and determined marks are given according to a comparison result, and obtained marks are treated as word similarity degrees and words or phrases of a high degree of word similarity in the second language sentence in the second language included in each of the similar translation examples are associated with the words or the phrases corresponding to the translation words or the translation phrases in the first language sentence in the first language included in each of the similar translation examples.

4. The translation support program according to claim 3, wherein when words or phrases in the first language sentence in the first language included in each of the similar translation examples are associated with words or phrases in the second language sentence in the second language included in each of the similar translation examples, the translation words or the translation phrases are compared with the words or the phrases in the second language sentence in the second language included in each of the similar translation examples and predetermined marks are given to words or phrases in the second language sentence in the second language included in each of the similar translation examples that match the translation words or the translation phrases, and additional predetermined marks are given according to priority set in advance for each of the translation words or the translation phrases.

5. The translation support program according to claim 3, wherein predetermined marks are given if words or phrases in the second language sentence in the second language included in each of the similar translation examples match words or phrases in the first language sentence in the first language included in each of the similar translation examples in representation.

6. The translation support program according to claim 1, wherein if a word or a phrase in the second language sentence in the second language included in each of the similar translation examples is associated with a plurality of words or phrases in the first language sentence in the first language included in each of the similar translation examples when words or phrases in the first language sentence in the first language included in each of the similar translation examples are associated with words or phrases in the second language sentence in the second language included in each of the similar translation examples, association closer to words or phrases in the first language sentence in the first language and the second language sentence in the second language included in each of the similar translation examples between which association has been established is selected.

7. A word association program for associating words or phrases in a first language sentence in a first language with words or phrases in a second language sentence in a second language translated from the first language sentence in the first language, the program making a computer perform the processes of:
inputting the first language sentence in the first language and the second language sentence in the second language;
searching a bilingual dictionary for a translation word or a translation phrase for each word or each phrase in the first language sentence in the first language and extracting the translation word or the translation phrase;
comparing the translation word or the translation phrase with a word or a phrase in the second language sentence in the second language; and
associating a word or a phrase in the first language sentence in the first language corresponding to the translation word or the translation phrase similar to a word or a phrase in the second language sentence in the second language on the basis of comparison results with the word or the phrase in the second language sentence in the second language.

8. A translation support method for supporting translation by selecting translation examples similar to a sentence to be translated from among a plurality of translation examples registered in advance and by indicating the translation examples together with the sentence to be translated, the method comprising the steps of:
inputting a sentence to be translated, being a first language sentence in a first language, by an input section and retrieving similar translation examples similar to the sentence to be translated from a translation example storage section that stores translation examples each including a combination of a first language sentence in the first language and a second language sentence in a second language translated from the first language sentence in the first language by a similar translation example retrieval section with the sentence to be translated as a search key;
calculating similarity degrees between the retrieved similar translation examples and the sentence to be translated by a ranking section by the use of a predetermined similarity degree calculation method, and arranging the similar translation examples in order by the ranking section according to the similarity degrees;
extracting translation words or translation phrases corresponding to words or phrases in the first language sentence in the first language included in each of the similar translation examples from a bilingual dictionary by a word association section, comparing the translation words or the translation phrases with words or phrases in a second language sentence in the second language included in each of the similar translation examples by the word association section, and associating the words or the phrases in the first language sentence in the first language included in each of the similar translation examples with the words or the phrases in the second language sentence in the second language included in each of the similar translation examples by the word association section; and
highlighting words or phrases in the sentence to be translated and the first language sentence in the first language and the second language sentence in the second language included in each of the similar translation examples which are associated with each other.

9. A translation support apparatus for supporting translation by selecting translation examples similar to a sentence to be translated from among a plurality of translation examples registered in advance and by indicating the translation examples together with the sentence to be translated, the apparatus comprising:
a translation example storage section for storing translation examples each including a combination of a first language sentence in a first language and a second language sentence in a second language translated from the first language sentence in the first language;
a bilingual dictionary storage section for storing a bilingual dictionary of words or phrases included in the first language sentence in the first language and the second language sentence in the second language;
a similar translation example retrieval section for inputting a sentence to be translated, being a first language sentence in the first language, and for retrieving similar translation examples similar to the sentence to be translated from the translation example storage section with the sentence to be translated as a search key;
a ranking section for calculating similarity degrees between the retrieved similar translation examples and the sentence to be translated by a predetermined similarity degree calculation method, and for arranging the similar translation examples in order according to the similarity degrees;
a word association section for extracting translation words or translation phrases corresponding to words or phrases in the first language sentence in the first language included in each of the similar translation examples from the bilingual dictionary, for comparing the translation words or the translation phrases with words or phrases in the second language sentence in the second language included in each of the similar translation examples, and for associating the words or the phrases in the first language sentence in the first language included in each of the similar translation examples with the words or the phrases in the second language sentence in the second language included in each of the similar translation examples;
a search result display section for highlighting words or phrases in the sentence to be translated and the first language sentence in the first language and the second language sentence in the second language included in each of the similar translation examples which are associated with each other; and
a highlight control section for more conspicuously highlighting, in the case of one of the highlighted words or phrases in the sentence to be translated and the first language sentence in the first language and the second language sentence in the second language included in each of the similar translation examples being selected, the selected word or phrase and other two words or phrases corresponding to the selected word or phrase.
